(19) United States
(12) Patent Application Publication
(10) Pub. No.: US 2015/0120171 A1
(43) Pub. Date: Apr. 30, 2015

(54) METHOD FOR CONTROLLING A PRESSURE CONTROL VALVE OF A FUEL INJECTION SYSTEM, IN PARTICULAR OF A MOTOR VEHICLE

(71) Applicant: Robert Bosch GmbH, Stuttgart (DE)

(72) Inventors: Achim JENNE, Oberaichen (Leinfelden/Echterd) (DE); Tobias HILLENBRAND, Ludwigsburg (DE)

(21) Appl. No.: 14/523,441

(22) Filed: Oct. 24, 2014

(30) Foreign Application Priority Data
Oct. 29, 2013 (DE) 10 2013 221 981.4

(51) Int. Cl. F02D 41/38

(52) U.S. Cl. CPC F02D 41/3845
USPC 701/104

(57) ABSTRACT

A method for controlling a pressure control valve which controls the pressure in a high-pressure accumulator of a fuel metering system of an internal combustion engine, fuel being metered into the combustion chambers of the internal combustion engine from the high-pressure accumulator, and the pressure control valve being connected to the high-pressure accumulator and controlling the outflow of fuel from the high-pressure accumulator into a low-pressure accumulator, and it being provided, in particular, that in the case of a closed pressure control valve, the energization of the pressure control valve is reduced until the pressure control valve opens, and a close offset input is ascertained based on the energization present at the opening of the pressure control valve.

### RELATED APPLICATION INFORMATION

The present application claims priority to and the benefit of German patent application no. 10 2013 221 981.4, which was filed in Germany on Oct. 29, 2013, the disclosure of which is incorporated herein by reference.

### FIELD OF THE INVENTION

The present invention relates to a method for controlling a pressure control valve of a fuel metering system of an internal combustion engine, in particular of a motor vehicle according to the definition of the species in Claim 1. Furthermore, the present invention relates to a computer program which carries out all steps of the method according to the present invention when it runs on an arithmetic unit or a control unit, as well as a computer program product having program code, which is stored on a machine-readable medium, for carrying out the method according to the present invention, when the program runs on an arithmetic unit or a control unit.

### BACKGROUND INFORMATION

German patent document DE 10 2004 049 812 A1 discusses a fuel metering system which is involved here, in particular a fuel injection system of a common-rail (CR) system as well as a method for operating same. The fuel injection system has a high-pressure pump which is supplied with fuel via a metering unit, e.g., a pressure control valve, and which pumps the supplied fuel into a fuel accumulator (i.e., the so-called “rail” in this case) at a high pressure. Fuel is injected from the fuel accumulator into the combustion chambers of the internal combustion engine with the aid of injection valves or injectors. The metering unit, which is situated upstream from the high-pressure pump, controls the fuel supply to the high-pressure pump and thus to the fuel accumulator (rail). Additionally, a pressure control valve which controls the fuel outflow from the fuel accumulator, which is under high pressure, into a low-pressure system is situated at the fuel accumulator.

A pressure control valve which is involved here is operated electrically in most cases and is known to have a driver coil or a coil winding, with the aid of which an armature is driven for the purpose of opening and closing the pressure control valve. In general, a higher energization of the pressure control valve causes the pressure control valve to close, whereas a correspondingly lower energization results in the opening of the pressure control valve. In order to control the pressure in the fuel accumulator, a pressure sensor is additionally situated, with the aid of which the pressure, which is instantaneously present in the fuel accumulator, is measured.

The pressure control valve is activated via the control signal of the pressure control valve during the above-mentioned control with the aid of a characteristic curve of the connection “pressure” in the fuel accumulator and a predefined pressure setpoint value is set in this way. The above-mentioned control signal is, in most cases, a current signal, with the aid of which the pressure control valve is energized in an activating manner.

The activation of the pressure control valve takes place in a so-called “control operating mode” at maximum flow rate through the above-mentioned high-pressure pump, a corresponding pressure being set in the fuel accumulator based on a certain control signal or control current. In another operating mode, the so-called “metering operating mode,” the pressure control valve is closed. In order to ensure that the pressure control valve is securely closed in this operating mode, the inherent tolerances of the pressure control valve, e.g. resulting from manufacturing tolerances or aging effects, with regard to the closing force or the reseating pressure must be taken into consideration or allowed for during the activation. This may result in reseating pressures of up to 500 bar above the pressure setpoint value to be instantaneously set. This reseating pressure input is mostly referred to as “close offset”.

The close offset has the disadvantage that in operating situations of the internal combustion engine in which a rapid pressure reduction is necessary in the case of the closed pressure control valve, e.g., in the case of a transition from the full-load operation to the coasting mode, the above-mentioned reseating pressure input must initially be reduced before the pressure control valve may open for the purpose of effectuating the actual pressure reduction. The delay of the pressure reduction resulting therefrom results in pressure overshoots in the fuel accumulator, since the pressure reduction takes place in a chronologically shifted manner with regard to the pressure changes which occur due to the fuel injection with the aid of injectors mentioned above.

In addition, the magnitude of the reseating pressure input differs on a regular basis among the individual pressure control valves due to the above-mentioned reasons, i.e., manufacturing tolerances and/or aging effects. This additionally results in individually differently high overshoots of the pressure in the fuel accumulator, which, in turn, has a negative effect on the material stability of the high-pressure system and must therefore be taken into consideration during a load collective test.

Moreover, the above-mentioned reseating pressure input has an effect on the so-called “pressure stack-up” which identifies a pressure input for the fuel accumulator of a CR system which is to be taken into consideration during the development of CR high-pressure components for the purpose of factoring in potentially occurring overshoots of the pressure in the fuel accumulator through appropriate component stability. Such high-pressure components may include the fuel accumulator itself, an above-mentioned metering unit, an above-mentioned pressure control valve, or an above-mentioned pressure sensor.

### SUMMARY OF THE INVENTION

The present invention involves detecting the exact point in time of the mechanical opening of a pressure control valve involved here by decreasing the energization of the initially closed pressure control valve until the pressure control valve opens and an outflow of fuel sets in from the fuel accumulator or high-pressure accumulator. If the exact opening point in time and the associated energization as well as the pressure in the fuel accumulator present in this case are known, a close offset input mentioned at the outset may be ascertained or taught as a function of the particular pressure in the fuel accumulator.

The detection or ascertainment of the exact opening point in time of the pressure control valve takes place indirectly, i.e., via the current which is generated through electrical induction into the coil winding of the pressure control valve, according to one embodiment of the method according to the present invention. For this purpose, the technical effect is utilized that, due to the opening of the pressure control valve with the aid of induction, according to Lenz's law, a measurable or evaluatable current signal is generated, i.e., in particular an electric current which is caused and reverse induced due to the opening of the pressure control valve. This electrical detection of the opening state of the pressure control valve takes place considerably more rapidly than a mechanical or a hydraulic detection or ascertainment, for example, based on pressure change data.

The close offset input may be, in particular, ascertained or taught as a function of the individual manufacturing tolerances and of the particular pressure in the fuel accumulator, thus effectively counteracting the manufacturing tolerances mentioned at the outset.

The close offset input may be computed by adding a predefined current input value to the energization value which is instantaneously present during the opening of the metering unit. In this way, a secure closure of the pressure control valve is ensured due to a delayed application of the close offset input and, at the same time, the disadvantages described at the outset in the case of a necessary rapid pressure reduction in the fuel accumulator are effectively prevented in the event of a closed pressure control valve.

By carrying out at least two of this type of measurements at different pressures in the fuel accumulator, the close offset input may be determined or taught across a great pressure range or even essentially, across the entire pressure range which is available in the fuel accumulator. The values of the close offset input energization which result therefrom as well as the associated pressure values of the fuel accumulator may be stored in a characteristic field, a characteristic curve, a table, or a corresponding data structure in order to be able to retrieve these values during the subsequent operation of the pressure control valve.

The present invention also includes the utilization of a pressure control valve, which is known per se, as an adaptive pressure limiting valve, because with the aid of the present invention, each pressure control valve may be kept closed by an individual, which may be minimal input during the above-mentioned metering operating mode.

Due to the changes in the operating point of the internal combustion engine or of the fuel metering system, such as the above-mentioned transition from the full-load operation to the coasting mode or rapid pressure increases or temporary or local overshoots of the pressure in the fuel accumulator caused by rapid load changes are significantly reduced or even effectively prevented with the aid of the present invention. In this way, the mechanical stress on the high-pressure components of the fuel metering system is significantly reduced. Accordingly, the necessity of an above-mentioned “pressure stack-up” which identifies a pressure input for the fuel accumulator of a CR system which is to be taken into consideration during the development of CR high-pressure components for the purpose of factoring in potentially occurring overshoots of the pressure in the fuel accumulator through appropriate component stability, is reduced or prevented.

The method according to the present invention thus makes it possible, in particular due to the learning function mentioned above, to control more accurately the individual closing current of a pressure control valve involved here. In addition, the present invention makes possible the implementation of an above-mentioned OPC function which is used to prevent overpressure in the fuel accumulator. With the aid of the learning function, the entire system behavior of the CR system is thus improved, namely in particular independently of the particular operating mode of a pressure control present in the high-pressure system.

The present invention may be utilized in a pressure-operated fuel metering system of a motor vehicle, in particular in a high-pressure-operated CR injection system. However, it is understood that the method may also be employed with the advantages described herein beyond the conventional automotive technology, e.g., in special commercial vehicles, in watercraft, or in chemical process engineering.

Further advantages and embodiments of the present invention are derived from the description and the attached drawings.

It is understood that the above-mentioned features and the features to be elucidated below are usable not only in the given combination, but also in other combinations or alone without departing from the scope of the present invention.

### BRIEF DESCRIPTION OF THE DRAWINGS

FIG. 1 shows a schematic block diagram of a fuel injection system involved here according to the related art in which the method according to the present invention is applicable.

FIGS. 2a, 2b show electric current profiles which are measured at a pressure control valve involved here for the purpose of illustrating the reverse induced current during an opening process of the pressure control valve.

FIG. 3 shows one exemplary embodiment of the method according to the present invention with reference to a flow chart.

FIG. 4 schematically shows the profile of a pulse-width-modulated control voltage for the operation of a pressure control valve involved here for the purpose of illustrating the current measuring method applied according to the present invention.

### DETAILED DESCRIPTION

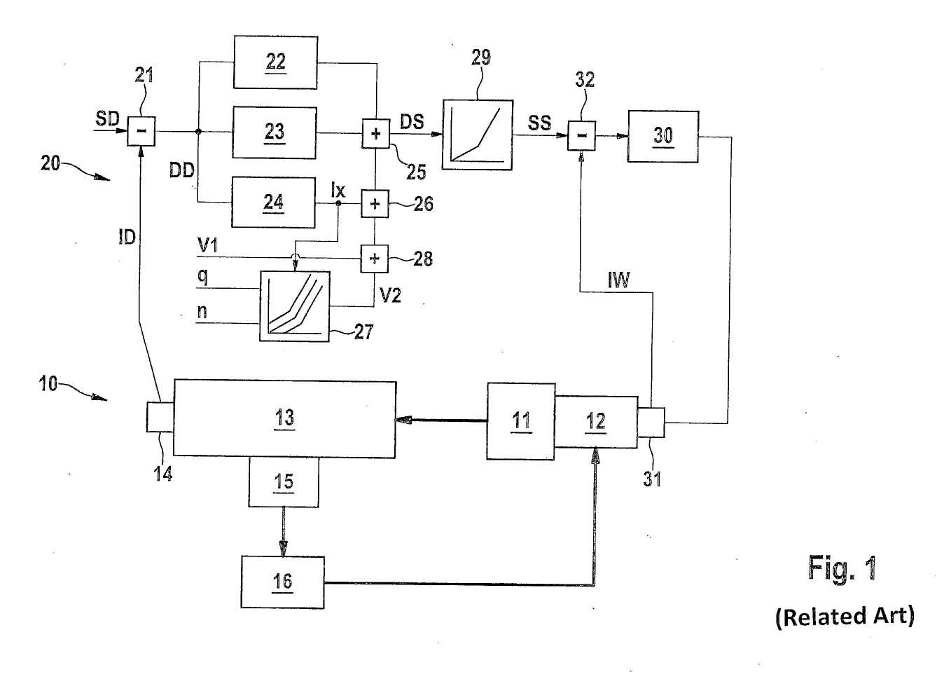

In FIG. 1, a fuel injection system 10 of an internal combustion engine is illustrated, a high-pressure fuel injection system of a diesel internal combustion engine for a motor vehicle may be involved. Fuel injection system 10 has a pump 11, in particular a high-pressure pump, which is supplied with fuel via a metering unit 12. Pump 11 is connected on the output side to a fuel accumulator 13, in which the fuel is stored under a pressure. In a manner which is not illustrated here, fuel accumulator 13 is connected to the injectors via which the fuel is injected into the combustion chambers of the internal combustion engine. A pressure control valve 15, with the aid of which the outflow of fuel from fuel accumulator 13 which is under high pressure (i.e., high-pressure accumulator) to a low-pressure accumulator 16 which is indicated only schematically takes place in a controlled manner, is connected to or situated at fuel accumulator 13, whereby the pressure is controllable in fuel accumulator 13. In order to control the pressure in fuel accumulator 13, i.e., in order to ascertain an actual value of the pressure, a pressure sensor 14, in particular a rail-pressure sensor (RPS) mentioned at the outset, with the aid of which the pressure in fuel accumulator 13 is measured, is assigned to fuel accumulator 13.

Entire fuel injection system 10 is controlled and/or regulated by a control device which is not illustrated in greater detail. For this purpose, the control device has a computer including an electrical storage medium, in particular having a flash memory. A computer program which may run on the computer is stored on the storage medium. This computer program is suited to influence fuel injection system 10 and thus to carry out the desired control and/or regulation.

In addition to fuel injection system 10, a method 20 for operating this fuel injection system 10 is illustrated in FIG. 1 in the form of a block diagram. This method 20 is carried out by the control device. Parts of method 20 may also be implemented with the aid of analog electronic components, if necessary.

A signal which corresponds to actual pressure ID in fuel accumulator 13 is generated by pressure sensor 14 and transmitted to a comparator 21. This is where actual pressure ID is compared to a setpoint pressure SD. Differential pressure DD is forwarded to three controllers, namely a P controller 22 (proportional controller), a D controller 23 (differential controller), and an I controller 24 (integral controller). The outputs of these three controllers are added together by an adder 25 to form a control value DS for a desirable fuel flow rate. This desirable fuel flow rate should then be supplied by metering unit 12 to pump 11 and thus to fuel accumulator 13.

Furthermore, a first pilot control signal V1 is provided which is added to control value DS via a first adder 26, and a pilot control characteristic field 27 is provided which supplies on the output side a second pilot control signal V2 which is added to control value DS for the fuel flow rate via a second adder 28. Instantaneous injection quantity q and instantaneous rotational speed n are supplied to pilot characteristic field 27 as the input signals.

Control value DS for the desirable fuel flow rate is supplied to a characteristic curve 29 which represents metering unit 12. With the aid of this characteristic curve 29, that control value SS is ascertained for a current from control value DS which must be used to activate metering unit 12 in order to generate the desirable fuel flow rate. This control value SS represents a setpoint value for a current controller 30 situated downstream. This current controller 30 then applies the current which corresponds to control value SS to metering unit 12. The current which actually flows through metering unit 12 is measured by a sensor 31 and supplied to a comparator 32 as actual value IW. This is where actual value IW is subtracted from control value SS. The difference then acts on current controller 30.

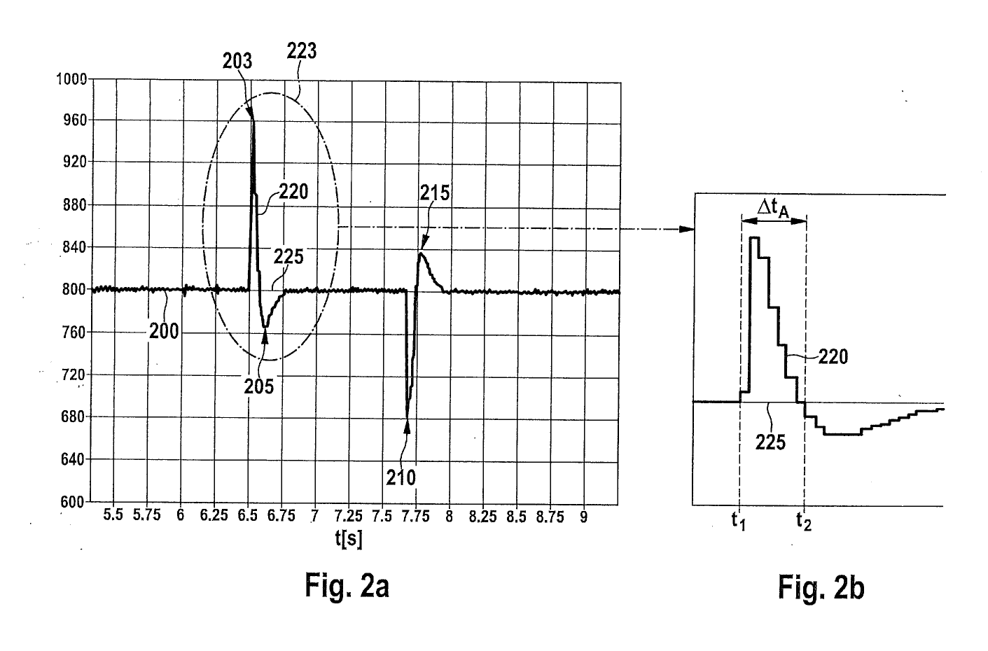

The method described in the following for controlling a pressure control valve 15 shown in FIG. 1 may be based on an exact ascertainment of its opening point in time. Here, the fact is utilized, in particular, that according to Lenz's law, an electric induction current is (temporarily) generated or reverse induced in the driver coil or winding of pressure control valve 15 during the opening of pressure control valve 15. This temporary current change is detected and an opening pressure control valve 15 is inferred therefrom, the opening taking place due to the fact that the rail pressure acting on pressure control valve 15 is greater than the reseating pressure set by pressure control valve 15. The above-mentioned current which is reverse induced during the opening process of pressure control valve 15 is illustrated with reference to the measuring curve shown in FIGS. 2a and 2b.

FIG. 2a shows an electric current profile I_{DRV}, which is measured at a pressure control valve in the unit milliampere (mA) as actual value 200 of the current, as well as a predefined setpoint value 225 of the current. In time window 223, which is emphasized by a dashed line, a temporary current rise 220 of actual value 200 results which is used in the method described here as the basis for determining the exact opening point in time of the pressure control valve.

In FIG. 2a, the current profiles are illustrated which result during opening as well as the subsequent closing of pressure control valve 15. Shown peak-shaped rise 203 results from the opening of pressure control valve 15, whereas slighter undershoots 205 result from the control intervention of the current controller which is caused by the current peak. During the closing of pressure control valve 15, a peak-shaped undershoot 210 which is due to the corresponding reverse induction initially results, and a subsequent slighter overshoot 215 results which is also caused by an above-mentioned intervention of the current controller.

FIG. 2b shows an enlarged section of area 223, which is shown in FIG. 2a, of current rise 220 as well as of setpoint value 225. Due to the relatively high measuring resolution, the opening of pressure control valve 15 which, on present time scale t (s), lies at approximately t₁=6.5 s in the present exemplary embodiment, may be ascertained very exactly from this measuring curve of point in time t₁. Time duration Δt_{A}=t₂−t₁ of temporary current rise 220 is here only approximately 0.05 s. These time data show that the detection according to the present invention of the opening of pressure control valve 15 via an electric path (reverse induced current) is more rapid than the detection via a hydraulic path (e.g., via values supplied by the rail pressure sensor). With the aid of electrical variables, it may thus be detected more rapidly that pressure control valve 15 opens.

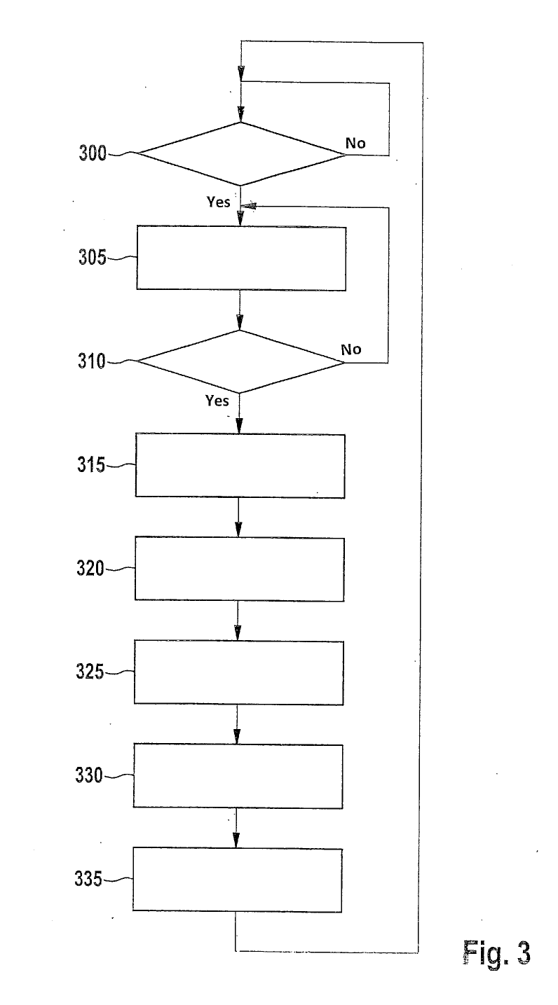

In the exemplary embodiment, which is shown in FIG. 3, of a routine according to the present invention, it is initially checked 300 whether pressure control valve 15 is closed. If this is not the case, the sequence jumps back to the beginning of the routine. If it is determined that pressure control valve 15 is closed, the energization of pressure control valve 15 is reduced by an empirically predefined differential value in subsequent step 305. It is then checked 310 whether the above-mentioned current measurement (which is described below in greater detail) has detected a reverse induced (peak) current. If this is not the case, the sequence jumps back to step 305 and the energization of pressure control valve 15 is correspondingly further reduced or minimized at the above-mentioned step interval. If after such an additional reduction of the energization, it results in checking step 310 that a reverse induced peak current was measured, the instantaneous pressure in fuel accumulator 13 is detected or read out from a control device of the internal combustion engine and buffered in subsequent step 315. In addition, the instantaneous value of the energization or the energization value which was present during the opening of pressure control valve 15 is buffered in step 320. The above-mentioned close offset input I_{DRV, close offset input} is computed in step 325 from instantaneous energization value I_{DRV,open} according to the following equation (1):

I_{DRV,close offset input}=I_{DRV,open}+ΔI_{offset} (1)

ΔI_{offset} representing what may be a minimal offset value which was previously empirically ascertained and whose magnitude ensures that pressure control valve 15 is securely closed during the activation with current value I_{DRV,close offset input}.

In step 330, the thus computed current values of close offset input I_{DRV,close offset input} are stored in a characteristic field together with the particular, assigned pressure values in fuel accumulator 13, and the discrete values are interpolated or extrapolated in a manner known per se in order to be available during subsequent operation of pressure control valve 15 at different pressures in fuel accumulator 13. The routine is ended in that the energization of pressure control valve 15 is increased back to the original current value (i.e., prior to the beginning of the routine) in step 335 in order to re-close pressure control valve 15 for normal operation.

The described method may be advantageously carried out in all possible operating states of an underlying fuel metering system (e.g., CR system) in which pressure control valve 15 is closed and thus used or carried out across the entire pressure range which is available in the rail, since the operating current or the control current for pressure control valve 15 may be reduced at any pressure in the above-described manner until an above-described opening signal of pressure control valve 15 may be measured or detected. Subsequently, the operating current of pressure control valve 15 may be rapidly increased again, whereby the temporary current reduction does not have any noticeable influence or negative effects on the instantaneously present rail pressure or the injection behavior of the CR system due to the rapid detection of the opening.

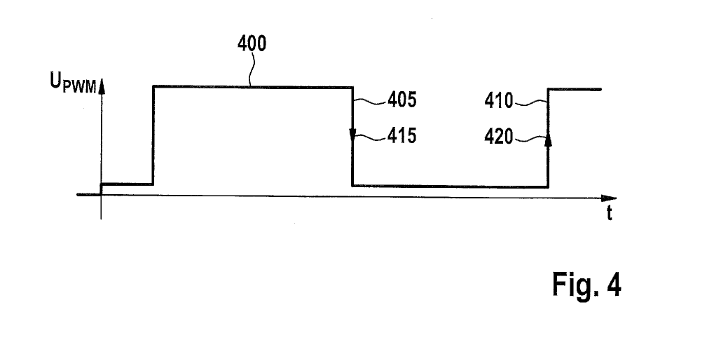

The above-described temporary current change, which may be a current rise, which is significant for the opening of pressure control valve 15 may be ascertained at an inductive load with the aid of the method for current measurement which is described in the following with reference to FIG. 4. In FIG. 4, a pulse-width-modulated (PWM) voltage signal 400 is schematically illustrated as a function of time t. The two signal edges 405, 410 of the PWM signal form the basis for the current measurement in the exemplary embodiment, a first current measurement 415 taking place at descending edge 405 and a second current measurement 420 taking place at rising edge 410.

The current measurement is, in particular, carried out chronologically synchronously at the two edges 405, 410 of PWM signal 400 and a mean value is formed from the obtained current values which correspond to a minimum current as well as to a maximum current. The resulting mean value is assumed to be a reverse induced current value.

It is apparent that the exemplary embodiment shown in FIG. 4 utilizes a control voltage signal which forms the basis for the activation of the pressure control valve and which effectuates the above-described control current through the coil of the pressure control valve. This voltage signal is, for example, present in a control device of the CR system and may therefore be read out accordingly for the purpose of evaluating the resulting currents at above-described voltage edges 405, 410.

The above-described method may be implemented either in the form of a control program in an existing control device for controlling an internal combustion engine or in the form of an appropriate control unit.

What is claimed is:

1. A method for controlling a pressure control valve which controls a pressure in a high-pressure accumulator of a fuel metering system of an internal combustion engine, the method comprising:
metering fuel metered into combustion chambers of the internal combustion engine from the high-pressure accumulator;
controlling, via the pressure control valve, which is connected to the high-pressure accumulator, an outflow of fuel from the high-pressure accumulator into a low-pressure accumulator;
reducing, for a closed pressure control valve, the energization of the pressure control valve until the pressure control valve opens; and
ascertaining a close offset input based on the energization present at the opening of the pressure control valve.

2. The method of claim 1, wherein the close offset input is computed by adding a predefined current input value to the energization value present during the opening of the pressure control valve.

3. The method of claim 1, wherein the ascertained close offset input of the pressure control valve is determined as a function of the individual manufacturing tolerances.

4. The method of claim 3, wherein the close offset input of the pressure control valve is determined at at least two different pressures in the fuel accumulator.

5. The method of claim 4, wherein the values of the close offset input which result from the at least two pressures are stored in the fuel accumulator as a function of the particular pressure in the form of a characteristic field, a characteristic curve, or a table and the pressure control valve is activated based on the characteristic field or the characteristic curve, or the table.

6. The method of claim 4, wherein the at least two pressures cover the entire pressure range which is available in the high-pressure accumulator.

7. The method of claim 1, wherein the opening of the pressure control valve is ascertained by a reverse induced electric current.

8. The method of claim 7, wherein at the end of the above-mentioned steps, the energization of the pressure control valve is increased to re-close the pressure control valve.

9. The pressure control valve of claim 1, wherein the pressure control valve is configured to control an inflow of fuel into a high-pressure accumulator of a fuel metering system of an internal combustion engine as an adaptive pressure limiting valve.

10. A computer readable medium having a computer program, which is executable by a processor, comprising:
a program code arrangement having program code for controlling a pressure control valve which controls a pressure in a high-pressure accumulator of a fuel metering system of an internal combustion engine, by performing the following:
metering fuel metered into combustion chambers of the internal combustion engine from the high-pressure accumulator;
controlling, via the pressure control valve, which is connected to the high-pressure accumulator, an outflow of fuel from the high-pressure accumulator into a low-pressure accumulator;
reducing, for a closed pressure control valve, the energization of the pressure control valve until the pressure control valve opens; and
ascertaining a close offset input based on the energization present at the opening of the pressure control valve.

11. The computer readable medium of claim 1, wherein the close offset input is computed by adding a predefined current input value to the energization value present during the opening of the pressure control valve.
